(19) United States
(12) Patent Application Publication
(10) Pub. No.: US 2020/0375693 A1
(43) Pub. Date: Dec. 3, 2020

(54) DENTAL COATING FOR PRESERVING TEETH

(71) Applicant: Dustin Lee Cohen, Los Angeles, CA (US)

(72) Inventor: Dustin Lee Cohen, Los Angeles, CA (US)

(21) Appl. No.: 16/880,401

(22) Filed: May 21, 2020

Related U.S. Application Data
(60) Provisional application No. 62/855,640, filed on May 31, 2019.

(51) Int. Cl. A61C 5/00; A61C 9/00; A61C 19/06

(52) U.S. Cl. CPC A61C 5/00; A61C 19/066; A61C 9/00

(57) ABSTRACT

A method can include applying a clear or mostly clear dental coating on one or more teeth for preserving the structure and/or appearance of the one or more teeth. The method can include bleaching the one or more teeth before applying the clear or mostly clear dental coating.

### CROSS-REFERENCE TO RELATED APPLICATIONS

This application claims priority to and the benefit of U.S. Provisional Application No. 62/855,640, filed May 31, 2019, the entire contents of which are herein incorporated by reference in their entirety.

### BACKGROUND

### 1. Field

This disclosure relates to dental procedures and coatings.

### 2. Description of Related Art

A traditional dental veneer procedure is predominately used to alter the appearance of the existing tooth in some way. In certain cases, preservation is desired instead of altering the appearance of the existing tooth.

Such conventional methods and systems have generally been considered satisfactory for their intended purpose. However, there is still a need in the art for improved dental procedures and coatings. The present disclosure provides a solution for this need.

### SUMMARY

A method can include applying a clear or mostly clear dental coating on one or more teeth for preserving the structure and/or appearance of the one or more teeth. The method can include bleaching the one or more teeth before applying the clear or mostly clear dental coating.

The method can include making a mold of the one or more teeth and forming the clear or mostly clear dental coating based on the mold. The method can include preparing the one or more teeth before applying the clear or mostly clear coating to the one or more teeth using one or more materials for preparation.

The method can include bonding the clear or mostly clear dental coating to at least the facial side of the one or more teeth. The method can include bonding the clear or mostly clear dental coating to the incisal side and partially to the lingual side of the one or more teeth.

The dental coating can be clear in certain embodiments. The dental coating can be made of a veneer material, for example, or any other suitable material.

A dental coating can include a clear or mostly clear material and configured to cover at least a facial side of a tooth. The clear or mostly clear material can be configured to be bonded to a tooth. The clear or mostly clear material can be a veneer material, for example.

These and other features of the embodiments of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a cross-sectional view of a tooth (e.g., a maxillary central incisor) having an embodiment of this disclosure disposed thereon in accordance with this disclosure, showing a dental coating on a facial side and wrapping around an incisal side of the tooth to the lingual side.

### DETAILED DESCRIPTION

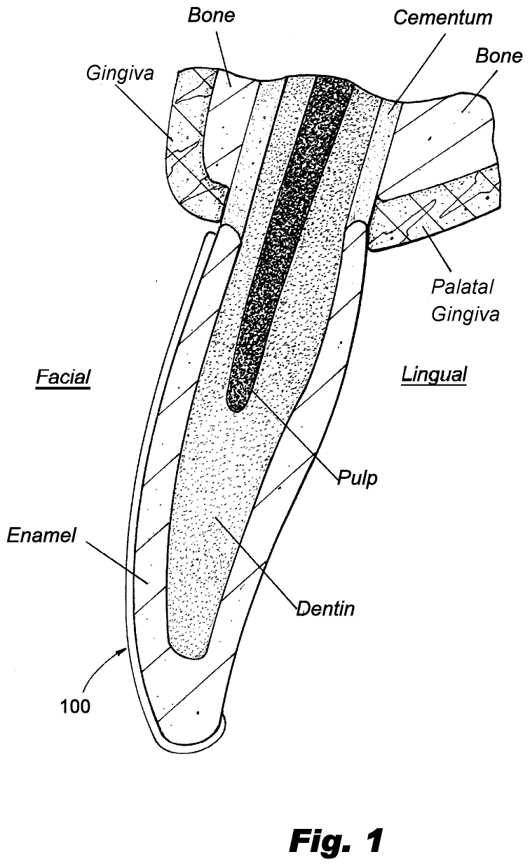

Reference will now be made to the drawings wherein like reference numerals identify similar structural features or aspects of the subject disclosure. For purposes of explanation and illustration, and not limitation, an illustrative view of an embodiment of a coating in accordance with the disclosure is shown in FIG. 1 and is designated generally by reference character 100.

Embodiments include a method for preserving existing tooth structure using a no-preparation or minimal preparation clear or semi-clear dental coating 100 (e.g., a veneer or onlay). The method can include applying the dental coating 100 to a tooth. The method can include applying the dental coating 100 only on the facial side of the tooth, or on the facial side and at least partially on the incisal and/or lingual side. Any other suitable portions of the method are contemplated herein.

The dental coating can act as a physical barrier to environmental factors including but not limited to abrasion, acid erosion, and external staining. This method can be done alone, e.g., for patients that are satisfied with the aesthetics of their existing teeth, but can be useful in prolonging the cosmetic benefits achieved by tooth bleaching procedures. Accordingly, the method can include first bleaching a tooth before applying the dental coating to the tooth.

Embodiments of the dental coating can be used to prolong the aesthetic color match of a natural tooth to an adjacent tooth with a full-coverage or partial-coverage restoration (e.g., a crown or veneer). The dental coating can also be used to match the texture, line angles, light reflection, and overall shine to adjacent restorations. The dental coating can be configured to not significantly alter the shape, size, color, positioning, or occlusion of the existing tooth. The dental coating can be about 0.1 mm to about 0.5 mm thick, or any other suitable thickness.

There is currently no widely known procedure that involves placing a dental coating (e.g., a veneer or onlay) for the prevention of tooth structure loss and as a barrier to external staining, for example.

Embodiment of a Protocol for the dental coating without bleaching:

First, an examination by the doctor to determine candidacy for the procedure can be had. Tooth characteristics that would be good candidates for the procedure can include, but are not limited to: minimal undercuts, overall pleasing aesthetics, minimal occlusal attrition, good oral hygiene, absence of occlusal disease, absence of decay, absence of significant fractures, absence of large existing restorations or compromised restorations. If patient is a good candidate, a final impression can be taken (numerous materials for impressions, discussed later). The impression can be used to fabricate the dental coating (e.g., by the dentist or by a lab). When the dental coating is ready, the patient can be brought back in for cementation. A standard dental veneer bonding procedure can be followed to bond the dental coating to the enamel of the teeth. The dentist can remove excess cement and remove any occlusal interferences, for example. A final polishing procedure can be completed and the dentist can instruct the patient to maintain a high level of oral hygiene along with regular dental cleanings to preserve the appearance of the coating.

Embodiment of a Protocol for the dental coating with bleaching:

The doctor can first examine the patient to ensure that they are a good candidate for the procedure. Next, the patient can undergo a bleaching procedure of their choice. In one example, a patient can undergo in-office treatment that includes 2 rounds of 20 minutes using 40% Hydrogen Peroxide and the dentist take final impression for fabrication of the dental coating. The patient can then be sent home with custom bleaching trays and bleaching gel and instructed to continue bleaching for approximately 2 more weeks, and then stop bleaching for 1 week to allow for enamel to rehydrate and allow for better bonding. The patient can then return to the office to have the dental coating applied to their teeth, e.g., using a protocol as described above.

In certain embodiments, the dental coating may be able to last for about 5 to about 15 years on average, depending on many factors such as biological factors and dental hygiene of the patient.

Embodiments of Materials used:

The Final Impression Material which is the material used to take mold of teeth can be Polyvinyl siloxane, Polyether, Vinyl Polyether Silicone, Alginate, or any other suitable material. An impression may be made with Digital scanning instead of physical materials.

The dental coating can be made of any suitable dental veneer or onlay material. Such materials can include feldspathic porcelain, leucite-reinforced porcelain, lithium disilicate, zirconia, and composite resins (composites come in many different types). Any other suitable material that can be made thin, translucent, and stain-resistant is contemplated herein. The dental coating can be made via hand layering, pressing, or milling.

Bonding materials are agents used to bond resin cement to ceramics and the tooth structure. Any suitable bonding agent is contemplated herein.

Materials for preparation of the intaglio surface of veneer can include hydrofluoric acid etch, phosphoric acid etch, Ivoclean (or similar phosphate removing agent), and a silane coupling agent, for example. Any other suitable material is contemplated herein.

Materials for preparation of enamel, dentin, cementum can include air abrasion with, e.g., 27 micron aluminum oxide and bonding system. There are many different combinations and systems that all include an acid etch component, a primer, and a bonding agent, for example. Any other suitable materials are contemplated herein.

Cement Materials can include resin cement which is the most commonly recommended cement for veneers and onlays. Many different shades, viscosities, brands are available. Resin cement has a superior hold for non-retentive dental restorations such as veneers and onlays compared to other cements. However, any other suitable cement is contemplated herein.

In accordance with this disclosure, a method can include applying a clear or mostly clear dental coating on one or more teeth for preserving the structure and/or appearance of the one or more teeth. The method can include bleaching the one or more teeth before applying the clear or mostly clear dental coating.

The method can include making a mold of the one or more teeth and forming the clear or mostly clear dental coating based on the mold. The method can include preparing the one or more teeth before applying the clear or mostly clear coating to the one or more teeth using one or more materials for preparation.

The method can include bonding the clear or mostly clear dental coating to at least the facial side of the one or more teeth. The method can include bonding the clear or mostly clear dental coating to the incisal side and partially to the lingual side of the one or more teeth.

The dental coating can be clear in certain embodiments. The dental coating can be made of a veneer material, for example, or any other suitable material.

In certain embodiments, a tinted cement can be used behind the dental coating to alter the color of the tooth without bleaching. For example, a white tinted cement under a clear dental coating can be used in order to brighten the tooth appearance without the need for bleaching. Embodiments can include using any other suitable color, e.g., a more yellow cement to match an existing tooth hue for other teeth of different colors and/or for a more natural look.

In accordance with this disclosure, a dental coating can include a clear or mostly clear material and configured to cover at least a facial side of a tooth. The clear or mostly clear material can be configured to be bonded to a tooth. The clear or mostly clear material can be a veneer material, for example.

Reasons for tooth structure loss, attrition on the occlusal/incisal aspects of the teeth can happen due to nocturnal bruxism (a brain-mediated disorder), occlusal disease (occlusal dysfunction caused by a posterior occlusal interference or constricted chewing pattern caused by an anterior occlusal interferences), using teeth as a tool, acid erosion, habitual clenching/grinding, medications causing grinding/clenching, or other causes. Attrition on the facial/buccal and lingual/palatal aspects of teeth can happen due to abrasion from toothpaste and toothbrush, occlusal overload, acid erosion, or other causes. Causes of tooth discoloration can include external factors such as smoking and darkly tinted food/drink that can leave surface stain on teeth (e.g., coffee, tea, beets, blueberries) and internal factors such as medications, trauma, genetics, blood particles, or other causes.

Embodiments can provide a protective layer to teeth and reduce the discoloration and structure loss. Embodiments can also provide prolonged aesthetic preservation after a bleaching or cleaning, for example, which can reduce cost in maintaining tooth appearance. Embodiments can be a barrier to stains, acids, abrasions, and sensitive areas on the teeth, allowing preservation of the tooth appearance in more than just one way.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

Any suitable combination(s) of any disclosed embodiments and/or any suitable portion(s) thereof are contemplated herein as appreciated by those having ordinary skill in the art.

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

What is claimed is:

1. A method, comprising:
applying a clear or mostly clear dental coating on one or more teeth for preserving the structure and/or appearance of the one or more teeth.

2. The method of claim 1, further comprising bleaching the one or more teeth before applying the clear or mostly clear dental coating.

3. The method of claim 1, further comprising making a mold of the one or more teeth and forming the clear or mostly clear dental coating based on the mold.

4. The method of claim 3, further comprising preparing the one or more teeth before applying the clear or mostly clear coating to the one or more teeth using one or more materials for preparation.

5. The method of claim 4, further comprising bonding the clear or mostly clear dental coating to at least the facial side of the one or more teeth.

6. The method of claim 5, further comprising bonding the clear or mostly clear dental coating to the incisal side and partially to the lingual side of the one or more teeth.

7. The method of claim 1, wherein the dental coating is clear.

8. The method of claim 7, wherein the dental coating is made of a veneer material.

9. A dental coating comprising a clear or mostly clear material and configured to cover at least a facial side of a tooth, wherein the clear or mostly clear material is configured to be bonded to a tooth.

10. The dental coating of claim 9, wherein the clear or mostly clear material is a veneer material.
